(19) United States
(12) Patent Application Publication
(10) Pub. No.: US 2006/0101134 A1
(43) Pub. Date: May 11, 2006

(54) Apparatus, method and article of manufacture for visualizing patterns of change and behavior on a compute infrastructure

(76) Inventors: David Nocera, Martinsville, NJ (US); Lorelei Wagner, New Port Richay, FL (US)

Correspondence Address: RICHARD I. SAMUEL;GOODWIN PROCTER L.L.P, 599 LEXINGTON AVE., NEW YORK, NY, 10022, US

(21) Appl. No.: 10/533,161

(22) PCT Filed: Oct. 29, 2003
(86) PCT No.: PCT/US03/34370

§ 371 Date: Oct. 24, 2005

Related U.S. Application Data
(60) Provisional application No. 60/422,005, filed on Oct. 29, 2002.

(51) Int. Cl. G06F 15/173

(52) U.S. Cl. 709/223

(57) ABSTRACT

Provided herein are exemplary techniques for visualizing patterns of changes and behavior on a compute infrastructure wherein a Differential View user interface provides for complete visualization of infrastructure change and behavior and further provides interactive filters that identify and display patterns of change and behavior, on a graduated scale, for the compute infrastructure as a whole and for specific groups within the infrastructure.

### CROSS REFERENCE TO RELATED APPLICATION(S)/CLAIM OF PRIORITY

This application claims the benefit of, and incorporates by reference in the entirety, International Application Number PCT/US03/34370, filed Oct. 29, 2003, which claims the benefit of U.S. Application No. 60/422,005, filed Oct. 29, 2002, also incorporated in its entirety herein.

This application relates to and incorporates by reference in the entirety, International Application Number PCT/US 02/18473, entitled “Apparatus, Method, and Article of Manufacture for Managing Change on a Compute Infrastructure,” filed Jun. 11, 2002.

### STATEMENT REGARDING FEDERALLY SPONSORED RESEARCH OR DEVELOPMENT

Not applicable.

### REFERENCE OF AN APPENDIX

Not applicable.

### FIELD OF THE INVENTION

The present invention relates generally to compute and/or network management and more particularly to an improved system, method, apparatus, and article of manufacture for visualizing patterns of changes and behavior on a compute infrastructure such as the one shown in FIG. 10.

### BACKGROUND OF THE INVENTION

Heretofore, compute infrastructure change visualization techniques involve programmed alerting generated by user defined events on individual technology components or processes. Determining what components have changed and isolating patterns of failure has been the responsibility of the individuals tasked with responding to alarms. As expected, the process is often time-consuming and cumbersome.

Furthermore, the existing focus of alerts on component or process failures undermines the ability of individuals to identify components with a pattern of success.

Accordingly, what is needed is a comprehensive way to visualize change on a compute infrastructure, and more particularly, a solution that detects and presents patterns of both positive and negative change on a compute infrastructure.

### SUMMARY OF THE INVENTION

The present invention (also called Differential View) addresses the aforementioned problems of the prior art by providing for, among other things, an improved apparatus, method and article of manufacture for visualizing patterns of change and behavior on a compute infrastructure. Differential View provides for complete visualization of infrastructure change and behavior and further provides interactive filters that identify and display patterns of change and behavior, on a graduated scale, for the compute infrastructure as a whole and for specific groups within the infrastructure. This allows any type of compute data to be consolidated and visualized; this view can occur pre- or post-database load, or without ever loading data to a database. Furthermore, the attribute-values may represent any defined test (unit, system, performance, or industrial process).

Other aspects, features and advantages of the present invention will become better understood with regard to the following description and accompanying drawings.

### BRIEF DESCRIPTION OF THE DRAWINGS

Referring briefly to the drawings, exemplary embodiments of the present invention will be described with reference to the accompanying drawings in which

FIG. 1 illustrates a graphical interface of an exemplary embodiment of the present invention.

FIG. 2 illustrates the group selection feature of an exemplary embodiment of the present invention.

FIG. 3 illustrates the group analysis feature of an exemplary embodiment of the present invention.

FIG. 4 illustrates the baseline comparison feature of an exemplary embodiment the present invention.

FIG. 5 illustrates the drill down feature of an exemplary embodiment of the present invention.

FIG. 6 illustrates an exemplary three-dimensional view of one embodiment of the present invention.

FIG. 7 illustrates the color intensity feature of an exemplary embodiment of the present invention.

FIG. 8 illustrates an exemplary embodiment of the customizable timeframe feature of the present invention.

FIG. 9 illustrates the user color selection feature of an exemplary embodiment of the present invention.

FIG. 10 illustrates an exemplary embodiment of a compute infrastructure suitable in accordance with the present invention.

### DETAILED DESCRIPTION OF THE INVENTION

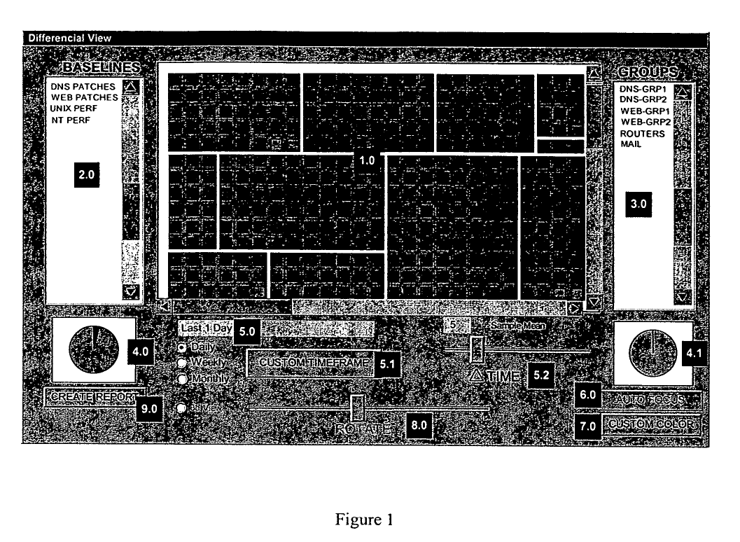

Referring more specifically to the drawings, for illustrative purposes aspects of the present invention is depicted in the exemplary embodiments generally shown in FIGS. 1-10. It will be appreciated that the illustrated embodiments may vary as to their details, for example, representative icons (a square may be a circle), configuration (the exact screen layout may be adjusted), etc., without departing from the basic concepts disclosed herein. The following description, therefore, should not to be taken in a limiting sense.

High Level Description

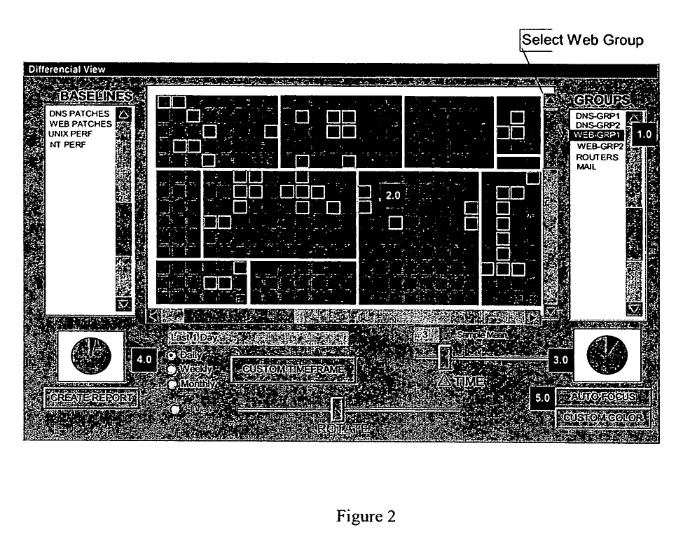

FIG. 1 illustrates a graphical representation of an exemplary embodiment of the present invention. As shown, the graphical view includes several underlying support mechanisms including: Colorized Grid of Nodes (FIG. 1-1.0) being monitored, grouped for ease of association (in this example, the white lines in the grid divide the nodes by location) colored by evaluation of change status. Note: The concept of Node is not limited to a physical object and can be extended to a logical concept like a business process, object or application a map of nodes; Baselines (FIG. 1-2.0): a selection of sets of predefined node attribute values with which to evaluate node conformity; Groups (FIG. 1-3.0): user defined node groupings for change and behavior pattern isolation; Pie Charts (FIG. 1-4.0, 4.1): for providing quantitative percentage of change within the selected set of nodes for referential comparison; Time Frame (FIG. 1-5.0, 5.1, 5.2): utilities from which to alter the time frame evaluated and presented; Auto Focus (FIG. 1-6.0): a utility which evaluates the groups to present those with the greatest deviation from expected values; Custom Color (FIG. 1-7.0): a utility to select the colors in which the graduated values for change appear; Rotate (FIG. 1-8.0): providing view control; Create Report t (FIG. 1-9.0): a report generator.

Visualization

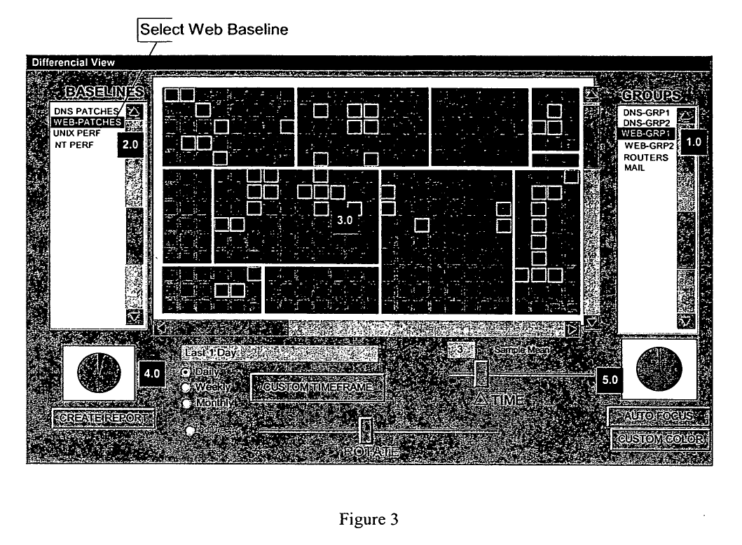

FIG. 2 illustrates the group selection progression of functionality listed in the description of FIG. 1. It presents the group pattern identification process which consists of the primary graphical view and supporting mechanisms: Selection of Groups (FIG. 2-1.0), select the group to be distinguished from the enterprise node view; Identification of Nodes within Group Selection (FIG. 2-2.0), nodes which belong to the selected Node Group are highlighted to be distinguished from the full population of nodes; Group Selection Pie Chart (FIG. 2-3.6) provides visualization of the quantitative percentage of change within the selected set of nodes; Node View Pie Chart (FIG. 2-4.0) provides visualization of the quantitative percentage of change in full population to provide a basis with which to compare the group to the whole. This ability provides a means by which to isolate the groups with the highest rate of change. The Auto Focus button (FIG. 2-5.0) when clicked, will automatically select and present the group with the most significant rate of change.

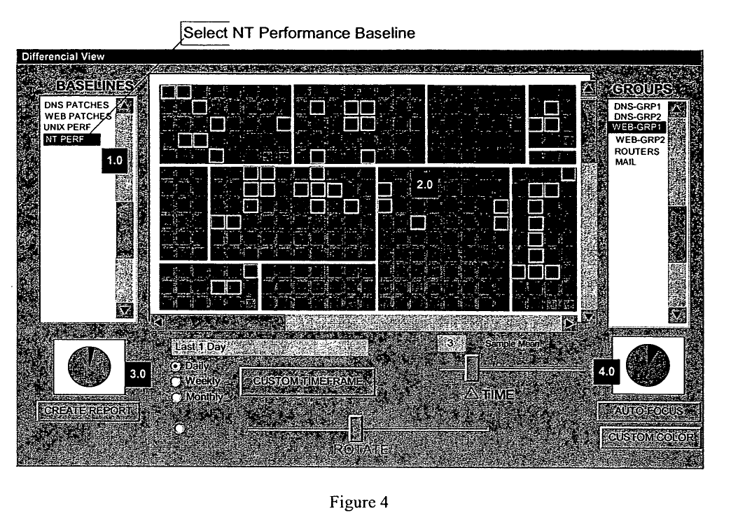

FIG. 3 progresses beyond group selection and into analysis of the group selection through Baseline Comparison.¹ It is not necessary to select a Group in order to select a baseline. One could look at a Baseline for patterns of change or behavior across the enterprise node view; however, patterns are more easily tracked when using both the Baseline and a Group. FIGS. 3 and 4 combined illustrate the use of Baseline compare to quickly analyze and isolate the set of attributes which are out of range within a Group. Selection of Groups (FIG. 3-1.0), select the group to be distinguished from the enterprise node view; Selection of Baseline (FIG. 3-2.0), select the Baseline through which to filter the node group (this example provides a visualization of nodes in WEB-GRP1 and how they align with the pre-established attribute-value pairs in the WEB-PATCHES Baseline). Node View (FIG. 3-3.0) presents the group nodes with the status relative to the Baseline; Node View Pie Chart (FIG. 3-4.0) continually provides visualization of the quantitative percentage of change in full population. Group Selection Pie Chart (FIG. 3-5.0) provides visualization of the quantitative percentage of change within the baseline for the selected set of nodes (in this example, 100% of WEB-GRP1 exactly match the WEB-PATCHES Baseline. This would quickly allow a system administrator to dismiss WEB-PATCHES as a problem area and allow him or her to look for other areas in which to find root cause of change.² Multiple Groups may be selected.

FIG. 4 illustrates the means with which to progress through the Baselines to identify the properties, or patterns, of the most intense change in the infrastructure. The group selected remains as it was in FIG. 3, i.e., Web-GRP1. Since, as described in FIG. 3, the User learned that the Baseline WEB-PATCHES had no changes, they move to another Baseline in an effort to identify a pattern of the change. Selection of Baseline (FIG. 4-1.0), select the Baseline through which to filter the node group (this example provides a visualization of nodes in WEB-GRP1 as filtered through the attribute-value associations of NT-PERF). Node View (FIG. 4-2.0) presents the group nodes with the status relative to the Baseline; Node View Pie Chart (FIG. 4-3.0) continually provides visualization of the quantitative percentage of change in full population Group Selection Pie Chart (FIG. 4-4.0) provides visualization of the quantitative percentage of change within the baseline for the selected set of nodes. Comparing the Node View Pie Chart to the Group View Pie Chart indicates quickly that the percentage of change is greater in the NT PERF Baseline than the greater population and indicates an area for further investigation.³ Multiple Baselines may be selected.

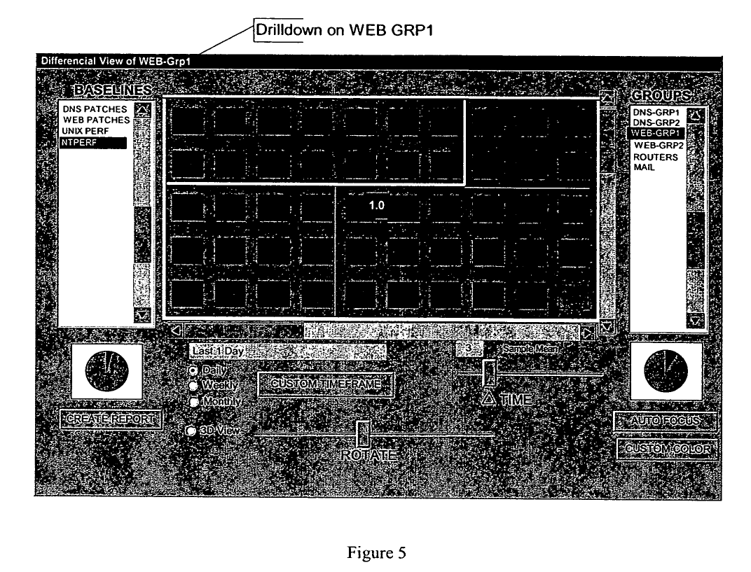

FIG. 5 depicts the drill down from FIG. 4, focusing specifically on the Node Group and Baseline selected at the point the User Drills Down. Node Group View (FIG. 5-1.0), presents the selected group nodes, delineated by location, with the status relative to the Baseline. The drill-down view reduces the number of nodes in the map, while leaving the remainder of the screen and its corresponding functionality intact.

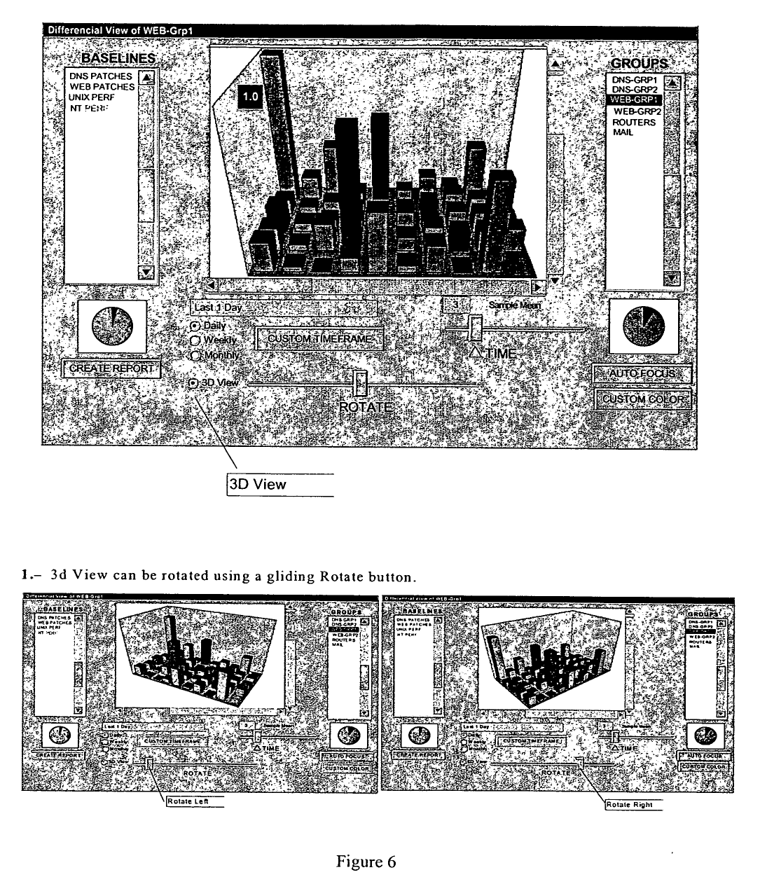

FIG. 6 illustrates alternate 3D views of Drill Down. 3D-Z Axis (FIG. 6-1.0) is the power axis and can be configured by the User to represent any key aspect of the nodes being monitored (e.g. CPU Power (3 of CPUs*CPU Speed), # of Users, Revenue,)

Color

The color assigned to a node is determined using a weighted moving average. Increasing the time of the sampled data for each attribute creates an average. The greater the percentage of change against that average, the greater the deviation and the greater the color shift (e.g. Green to Red).

The delta time is used to compute a moving average for each sample. Time is actually the number of samples back in time, e.g., if the Daily sample is selected (as shown in FIG. 6), a delta time of 5 equates to the average of the last five days. The maximum and minimum of the averages are used to compute the entire range of possibility.

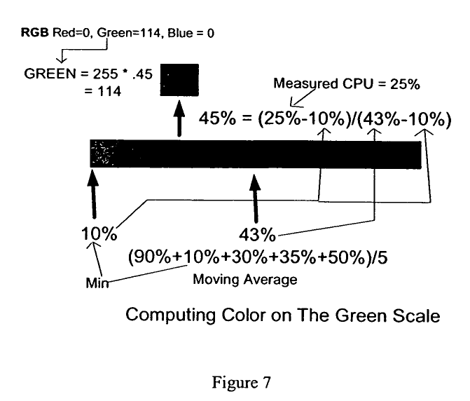

For example, if a CPU attribute is selected and it is currently 25%, and the last five days it was: 90%, 10%, 50% 50% and 50%, the min is 10%, the max is 90% and the moving average is (90+10+30+35+50)/5=43%. Since 25 is less then 43% it will be on the green scale where 10 is bright green and 43 is the midway point to red. To compute the exact color of green on the scale, 43−10 is 33 and 25−10=15, so 15/33 is the percentage of green on the scale. FIG. 7 depicts a graphical illustration of this point.

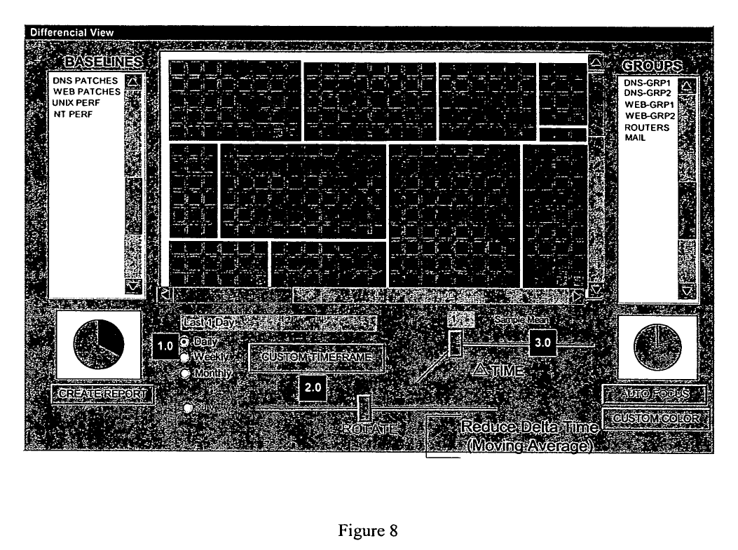

FIG. 8 identifies the radio button selections for time comparison (FIG. 7-1.0) Daily, Weekly and Monthly. The timeframe can be customized by using the Custom Timeframe Button (FIG. 7-2.0), this customization will allow complex time selections like each Monday between 2 PM and 5 PM. Sliding Sample Mean Time (FIG. 7-3.0) is used to allow the end user to change the default moving average in the computation of changes for Metrics types of attributes.

User Color Selection

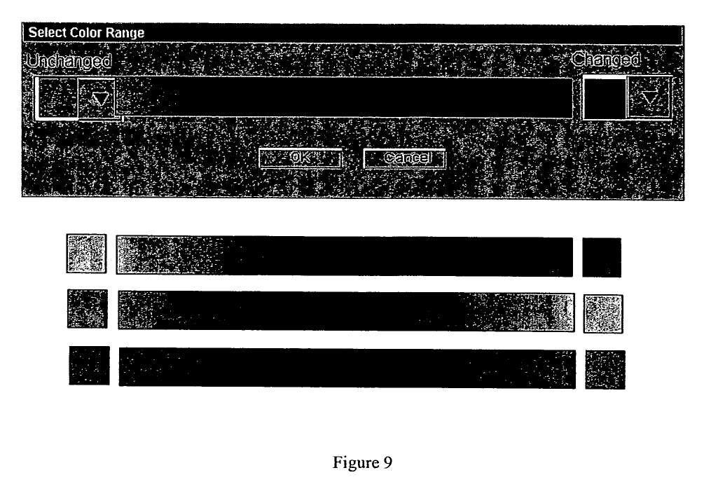

As shown in FIG. 9, a user can change the colors in their view according to the user preferences.

Compute Infrastructure

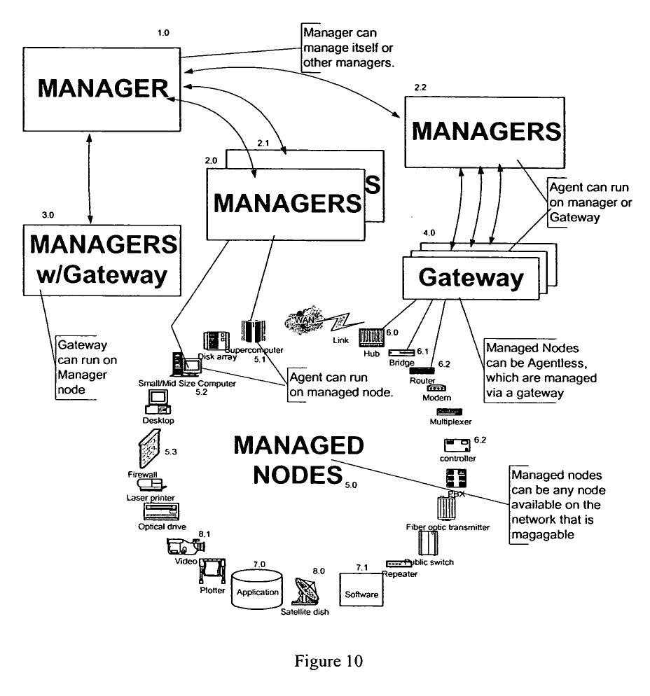

Finally, FIG. 10 illustrates an exemplary network/compute infrastructure having Managers (FIG. 10-1.0, 2.0, 2.1, 2.2), Managers with Gateways (FIG. 10-3.0), Gateways (FIG. 1-4.0), Managed Nodes with Agents (FIG. 10-5.1, 5.2, 5.3 etc), Managed Nodes that are Agentless (FIG. 10-6.0, 6.1, 6.2 etc), Software including application software, that can be managed like a node (FIG. 10-7.0, 7.1 etc.), and Special Devices that can be managed (FIG. 10-8.0, 8.1, etc).

### CONCLUSION

Having now described embodiments of the present invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

The techniques may be implemented in hardware or software, or a combination of the two. Specifically, the techniques may be implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices. Each program is preferably implemented in a high level procedural or object oriented programming language to communicate with a computer system, however, the programs can be implemented in assembly or machine language, if desired. In any case, the language may be a compiled or interpreted language. Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The invention may also be considered to be implemented as a computer-readable storage medium, configured with a computer program, where the storage medium so configured causes a computer to operate in a specific and predefined manner.

What is claimed is:

1. A method of visualizing patterns of change and behavior on a compute infrastructure having a plurality of nodes, said method comprising:
providing a set of color hues;
providing predetermined rates of change or behavior for each node of said compute infrastructure;
associating a color hue with a rate of node change or behavior;
monitoring said nodes to determine said rate of node change or behavior of each node;
displaying a colorized map of said nodes of said compute infrastructure;
displaying a first quantitative percentage of change graphic associated with said nodes of said compute infrastructure;
wherein for each of said nodes, displaying said color hue associated with said monitored rate of node change or behavior;

2. A method as in claim 1 further comprising:
providing one or more logical groupings of said nodes, each grouping having common node attributes;
selecting one of said logical node groupings;
identifying on said colorized map said nodes of said selected logical grouping;
displaying a second quantitative percentage of change graphic having a percentage of change associated with said nodes of said selected logical grouping.

3. The method as in claim 1, further comprising displaying textual data on at least a portion of said colorized map, said textual data comprising attribute information pertaining to said nodes of said compute infrastructure.

4. The method as in claim 2, further comprising:
providing a set of baseline attributes to evaluate node conformity;
selecting one of said baseline attributes;
identifying on said colorized map said nodes conforming to said selected baseline attribute;
displaying said second quantitative percentage of change graphic having a percentage of change associated with said nodes conforming to said selected baseline attribute.

5. The method as in claim 4, further comprising: displaying said colorized map comprising substantially of said nodes conforming to said selected baseline attribute.

6. The method as in claim 5, further comprising: displaying a three-dimensional graphic comprising said nodes conforming to said selected baseline attribute.

7. The method as in claim 1 wherein said first quantitative percentage of change graphic is a pie chart.

8. The method as in claim 2 wherein said second quantitative percentage of change graphic is a pie chart.

9. The method as in claim 1 wherein said first quantitative percentage of change graphic is a bar chart.

10. The method as in claim 2 wherein said second quantitative percentage of change graphic is a bar chart.

11. The method as in claim 1 wherein said color hues are determined using a weighted moving average.

12. The method as in claim 1 further comprising:
defining a timeframe;
monitoring said nodes to determine said rate of node change or behavior of each node during said time frame.
